(19) United States
(12) Patent Application Publication
(10) Pub. No.: US 2007/0073656 A1
(43) Pub. Date: Mar. 29, 2007

(54) Wireless device with application search function

(76) Inventor: Krishna Mohan Bandi, Bangalore (IN)

Correspondence Address: William S. Francos, Esquire;VOLENTINE FRANCOS & WHITT, PLLC., 11951 Freedom Drive, Suite 1260, One Freedom Square, Reston, VA, 20190, US

(21) Appl. No.: 11/239,513

(22) Filed: Sep. 29, 2005

(51) Int. Cl. G06F 17/30

(52) U.S. Cl. 707/3

(57) ABSTRACT

A mobile communication device and method of use are disclosed. The mobile communication device includes an alpha search function adapted to seek and retrieve application names, or application settings, or both from memory in a user-friendly manner.

### BACKGROUND

Wireless communications continue to increase in use and capacity. One type of wireless communications is wireless telephony. Wireless telephones, which often referred to as mobile phones or cell phones, are ubiquitous in today's society.

As the use of mobile phones has increased, so has the number of applications available on the phone. Illustratively, mobile phones include applications for messaging, profiles and call forwarding. Within each of these applications are stored settings. For example, in the profiles applications, ring tone settings are stored. A particular ring tone setting may be selected for a particular person, allowing the mobile phone user to recognize who is calling based on the ring tone.

The functionality of mobile phones is also increasing. For example, memory folders are often included in the functionality of the mobile phone, allowing the user to create folders and locate desired applications in specific folders.

While increased functionality provides the mobile phone user with greater resources in a single device, this increased functionality can also add complexity to the use of the device. Notably, once an application is stored in a selected folder, it is incumbent upon the user to remember the folder in which an application and the settings of each application are stored. With increasing applications available on mobile phones, locating an application, or setting, or both, can be tedious and time consuming.

There is a need for a mobile phone that overcomes at least the shortcomings described above.

### SUMMARY

According to an example embodiment, a method of accessing a memory of a mobile communication device includes initiating an alpha search. The method also includes entering a first character of the alpha search and selecting an application or a setting from a string of results of the alpha search.

According to another example embodiment, a mobile communication device includes a display, a keypad and a central processing unit (CPU) operatively connected to the keypad. The mobile communication device also includes a memory operatively connected to the CPU. At least one key on the keypad is adapted to initiate an alpha search of applications or settings, or both, that are stored in the memory. The CPU provides results of the alpha search from the memory to the display.

### BRIEF DESCRIPTION OF THE DRAWINGS

The example embodiments are best understood from the following detailed description when read with the accompanying drawing figures. Wherever applicable and practical, like reference numerals refer to like elements.

FIG. 1 is a perspective view of a mobile device in accordance with an example embodiment.

FIG. 2 is a simplified schematic diagram of a mobile device in accordance with an example embodiment.

FIG. 3 is a flow-chart of a method of accessing application names from a memory of a mobile device in accordance with an example embodiment.

FIG. 4 is a flow-chart of a method of accessing application settings from a memory of a mobile device in accordance with an example embodiment.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

Specific details will now be set forth with respect to example embodiments depicted in the attached drawings.

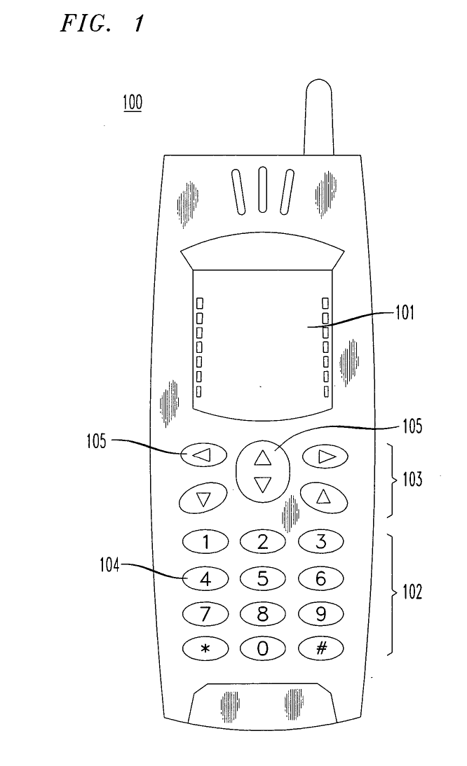

FIG. 1 is a perspective view of a mobile communication device 100 in accordance with an example embodiment. The device 100 includes a display 101, a keypad 102 and soft keys 103. The device 100 is illustratively a mobile phone. However, other types of mobile communication devices are contemplated. For example, the device 100 may be a personal digital assistant (PDA), a portable computer, or keypad cell phone, to name only a few.

The keypad 102 includes a plurality of alphanumeric keys 104. The keys 104 are electrically connected to a CPU (not shown in FIG. 1) and function as the interface between the user and the CPU and other electronics of the device 100. In addition, the device 100 includes at least one soft key 105. As is known, a soft key is a key that changes function depending on which mode or menu or screen is in use. For example, the alphanumeric key ‘ABC2’ provides the letters A, B, C or the letter 2 to the CPU and the display 101. However, a soft key 105 may be activated to perform a search on one menu of the display 101 and may function as a toggle for a cursor in another menu.

In example embodiments, the soft keys 105 are useful in performing the alpha search of application names, or the application settings, or both. In a specific embodiment, one of the soft keys 105 is configured in the idle screen of the display 101 to launch the alpha search feature. Beneficially, the user does not need to search for this feature on the device. Alternatively, the alpha search feature can also be set as the first application shown on the display 101 when the device 100 is powered on.

As described in further detail herein, in the example embodiments, the alpha search feature is an application setting adapted to carry out the configuration noted above. This setting allows the user to set an application of choice as the left or right soft key in the idle screen of the device 100. In this way, the user can directly launch the alpha search application by pressing either left or right soft key.

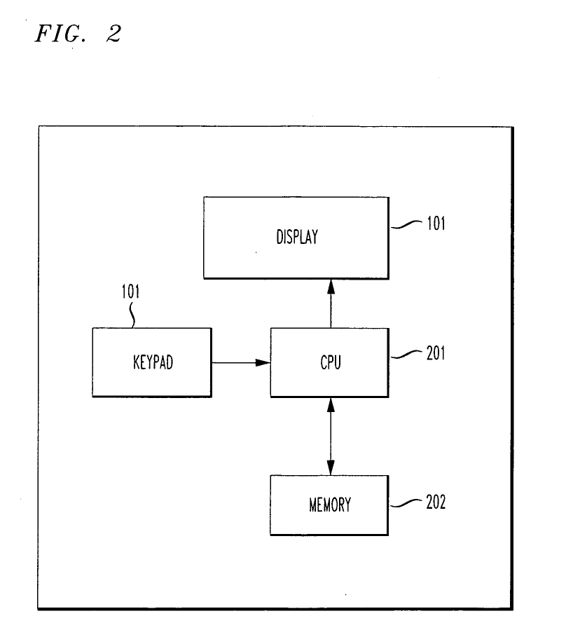

FIG. 2 is a simplified schematic diagram of the mobile device 100. The device includes the display 101 and the keypad 102 as described above. The keypad 102 is connected to a CPU 201. As is known, the alphanumeric group associated with each key of the keypad is stored in the CPU. When a key on the keypad is depressed, the CPU signals the display 101 to display the alphanumeric symbol of the particular key that is depressed. Although not shown, a display driver may connect the CPU 201 to the display 101 of the device 100. The signals from the CPU 201 may be transmitted to the display driver via a bus (not shown).

In a specific embodiment, the character displayed on the display 101 is based on a normal frequency distribution for standard prose. Of course, this is merely illustrative and it is emphasized that other known techniques for interfacing a keypad to a display are contemplated.

The CPU 201 may be a microprocessor adapted for use in a mobile communication device. Illustratively, the CPU is an ARM microprocessor and includes the Nucleus operating system provided commercially by Accelerated Technology Mentor Graphics, Inc. of Mobile Ala. (USA) or the Symbian OS operating system provided by Symbian Ltd. of London, UK.

The CPU 201 is coupled to a memory 202. The memory 202 may include submemory within the memory. Moreover, there may be more than one memory within the device 100. The memory 202 may include a programmable read only memory (PROM) such as an electrical erasable programmable read-only memory (EEPROM); a flash memory; and a random access memory (RAM). Within the memory 202 data useful in the function of the device 100 are stored. For example, the application names and application settings of the mobile device 100 are stored in the memory 202. These data may be segregated into folders within the memory. In a specific embodiment, the memory 202 writes and stores all the application names and application settings in a flash memory (registry), which is part of the memory 202. The registry is updated upon loading an application name or application setting.

The memory 202 is arranged according to a hierarchical file system (HFS). Such systems are well within the purview of one of ordinary skill in the art. Application names and application settings may be located in the files (also referred to as folders) of the HFS. During the power up of the device 100, the data of the memory are read from HFS system by the CPU 201 and written back to the HFS during power down of the device 100.

After initiating an alpha search on the device 101 with a soft key, the user presses a particular key on the key pad 102. In response to the signal from the display driver, the CPU 201 retrieves application names and application settings names from the memory 202, sorts the names in alphabetical order, and shows the sorted strings on the display 101. The retrieval of data from the memory is provided via an alpha search application control.

In a specific embodiment, in response to signals from the prompted keys on the keypad, the CPU 201 executes software code that is adapted to retrieve application names and application settings from the registry of memory 202. This software code is provided at the application layer of the CPU 201 and performs a search-and-retrieve operation seeking matching strings from the memory 202. The retrieved application names and application settings are then sorted at the CPU 201 via the software and are provided to the display 101 via the CPU 201 and the display driver. Notably, such search and retrieve software is within the purview of one of ordinary skill in the art, and many details are omitted in order to avoid obscuring the description of the embodiments.

As noted previously, the applications and settings may be rather large in number and disparate in utility. Accordingly, locating an application or setting can be rather complicated, particularly when the number of folders increases. However, and as detailed herein, one of more of the soft keys 105 is adapted to engage the CPU 201 to begin a search of all application names and application settings based on a single alpha key entry. The CPU 201 then recalls from memory 202 and provides to the display 101 a string of search results that begin with the selected alpha key. Moreover, to further refine the search, a successive alpha key is selected. The CPU 201 then recalls from memory 202 a string of search results that begin with the first two alpha keys selected. Naturally, this process can continue until the desired application or application setting is located on the display. Thereafter, another soft key may be used to highlight and select the application or setting desired.

In the example embodiments, the alpha search application is initialized during the start-up or power-up of the mobile device 100 and de-initialized during the power shutdown of the mobile device 100 like any other mobile application. The Alpha search feature of the example embodiments is an application that is registered via software with application manager during the initialization of the mobile device 100 and de-registered during the power shutdown of the mobile phone. All the information related to the application names and application settings names is stored in the registry of the device.

When the alpha-search feature is launched for the first time, the same information is read from the registry and maintained in a data structure. The data structure would contain the two fields: one field for the application name or the application setting name; and another field for a flag indicating if the first field in the data structure is an application name or application settings name. The flag fosters a more rapid search function. To this end, the application is launched or the application settings page is shown directly based solely on this flag. As such, when the user selects a string, the CPU 201 checks the flag and launches the string based on its the type (application name or application settings name).

The memory 202 also includes a cache memory, which is a RAM memory. The information of each data structure is stored in the cache memory and all the cached information is stored in the registry. Whenever there is a change in the cached information, the registry and cache memory are updated in that order. Beneficially, as the CPU 201 conducts an alpha search, the cache memory is read/queried first and, because the data structure information for application names and settings are stored in the cache memory, the CPU 201 does not need to read of data from the larger HFS database of the mobile device 100. As such, the alpha search may be carried relatively quickly.

As is known, many mobile devices are adapted to download new applications or delete downloaded applications. The downloaded/deleted application could be a software tool such as an application based on Java software language. During the initialization, the Alpha search application has to register a callback with the application manager software that provides information about new applications that are downloaded or applications that are deleted from the list of applications. This is readily carried out because all the existing applications have to be registered with the application manager. Thus, the application manager maintains a current listing of applications present. When the user downloads an application, the application manager is apprised of the addition, and the same information is passed on to the alpha search feature application. The alpha search feature then reads the different details of that application from the registry. The alpha search feature then updates the registry and the data structure information in the cache memory. Moreover, the user interface software is also updated to include new application names and new application settings names for display. Similarly, when the user deletes an application name/application setting from the memory 202, the application manager notifies alpha search application of the deletion. The alpha search application then updates the registry and the cache memory of the deletion.

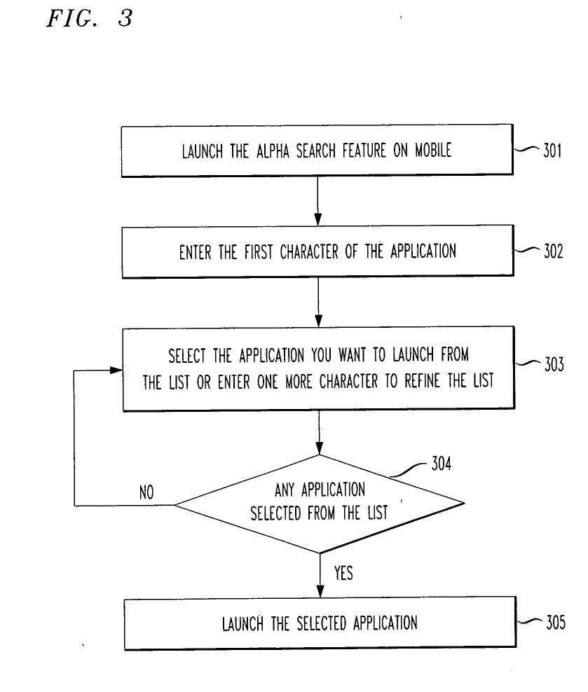

FIG. 3 is a flow-chart of a method of ascertaining an application in accordance with an example embodiment. At step 301, the alpha search feature is selected on the mobile communication device. This feature is displayed on the main menu of the display. The alpha search is launched by selecting one of the soft keys designated to launch the search. In a specific embodiment, the alpha search function cannot be moved to another folder so the user is not subject to searching for the feature itself.

At step 302, the user selects the first character (letter) of the desired application and engages the corresponding alpha key 104 from the key pad 103. The CPU 201 then garners all applications from the memory 202 and a list of strings is shown on the display. As noted previously, the CPU 201 garners the application names relatively quickly by reading the data structures from the cache memory. The list of strings is an alphabetical list of application names that begin with the selected alpha character.

At step 303, the user may select the application name from the list on the display or may continue the search. If the user identifies the application on the list the appropriate soft key is engaged to select the application from the list. However, it may be difficult to identify the application from a single alpha character because of the relatively long list of applications that begin with the selected alpha character. In this case, a second character is selected and the appropriate key on the keypad is engaged. The CPU 201 then extracts the applications that begin with the selected alpha characters. At step 304, using the keypad the user either selects from the list and continues to step 305 and launches the selected application. Alternatively, the user may select another character at step 303 and the process continues until the desired application is located. As before, at step 305, the application is launched.

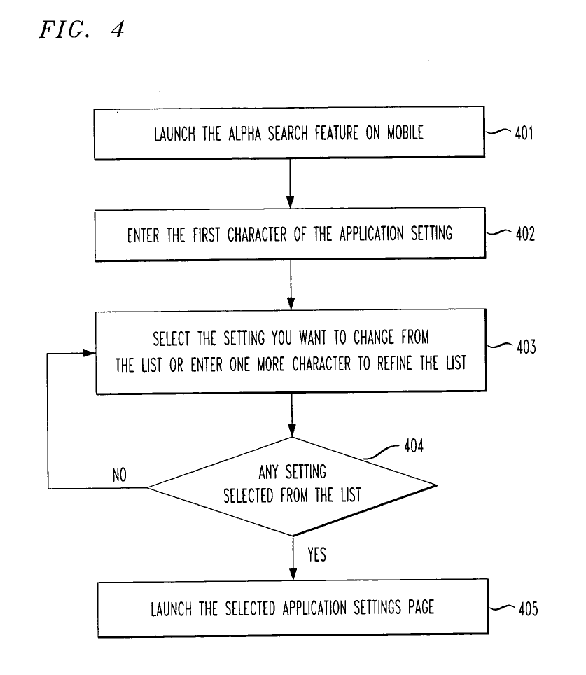

FIG. 4 is a flow-chart of a method of finding an application setting in accordance with an example embodiment. The method is quite similar to the method of FIG. 3. In fact, the methods of FIGS. 3 and 4 may be combined so a setting or an application may be searched in the same step.

At step 401, the alpha search feature is selected on the mobile communication device. This feature is displayed on the main menu of the display. The alpha search is launched by selecting one of the soft keys designated to launch the search. At step 402, the user selects the first character (letter) of the desired setting and engages the corresponding alpha key 104 from the key pad 103. Using the search function previously described, the CPU 201 then garners all application settings from the cache memory of memory 202 and a list of strings is shown on the display. The list of strings is an alphabetical list of application settings that begin with the selected alpha character.

At step 403, the user may select the desired setting from the list on the display or may continue the search. If the user identifies the setting on the list the appropriate soft key is engaged to select the application from the list. However, it may be difficult to identify the setting from a single alpha character. In this case, a second character is selected and the appropriate key on the keypad is engaged. The CPU 201 then extracts the settings that begin with the selected alpha characters. At step 404, the user either selects from the list and continues to step 405 and launches the selected application setting. Alternatively, the user selects another character is at step 403 to further refine the search and the process continues until the setting is selected. As before, at step 405, the setting is launched.

In an example, suppose a user wishes to modify the ring tone of a particular contact. The user would engage the soft key and commence the search for the ring tone settings. The user would then engage the key ‘PQRS7.’ The letter ‘P’ would then be displayed. The user would use the appropriate soft key to toggle through the letters of the key until ‘R’ appears on the display. The user then engages the key again and a string of settings that begin with ‘R’ are provided on the display. If the ring tone setting is readily viewed, the user engages the appropriate soft key and selects the ring tone settings page. If the ring tone setting is not readily identified, the user engages the key ‘GHI4’ on the key pad and toggles to the letter ‘I.’ After engaging the key again, the display provides all settings that begin with ‘RI.’ The process may continue if necessary; or the ring tone setting may be identified and launched at this point.

The methods and apparati of the example embodiments facilitate use of a mobile communication device. For example, suppose a mobile communication device includes software for up to 100 folders and there are 100 applications available. Suppose that the user has moved all the 100 applications to 100 different folders. By known methods, the user would have to recall the folder for each application or manually peruse each folder. However, by the ‘Alpha Search’ method of the example embodiments, the number of applications or folders stored on the device is substantially inconsequential. An application can be launched solely based on engaging two or three keys on the keypad.

In view of this disclosure it is noted that various methods and components described in conjunction with a mobile communication device of the example embodiments can be implemented in hardware and software. The present teachings are not limited to locating applications and settings and may be readily extended to other features stored on the device. Furthermore, the various methods, devices and parameters are included by way of example only and not in any limiting sense. In view of this disclosure, those skilled in the art can implement the various example devices and methods in determining their own techniques and needed equipment to effect these techniques, while remaining within the scope of the appended claims.

1. A method of accessing a memory of a mobile communication device, the method comprising:
initiating an alpha search;
entering a first character of the alpha search;
selecting an application name or an application setting from a string of results of the alpha search.

2. A method as recited in claim 1, wherein the first character is a letter.

3. A method as recited in claim 1, further comprising, before the selecting, entering at least one other character of the alpha search.

4. A method as recited in claim 1, wherein the string includes a plurality of application names or application settings, or both, and the string is provided on a display of the device.

5. A method as recited in claim 4, wherein each of the application names and application settings are stored in a memory of the mobile device.

6. A method as recited in claim 5, wherein the application names and application settings are stored in cache memory within the memory of the mobile device.

7. A method as recited in claim 3, further comprising repeating the entering of at least one other character of the alpha search.

8. A method as recited in claim 1, wherein the initiating, the entering and the selecting are effected via a keypad of the mobile device.

9. A method as recited in claim 1, wherein the Initiating further comprises engaging a softkey of the mobile communication device.

10. A method as recited in claim 1, wherein the alpha search further comprises searching the folders and retrieving matching strings from the folders.

11. A mobile communication device, comprising:
a display;
a keypad;
a central processing unit (CPU) operatively connected to the keypad;
a memory operatively connected to the CPU; and
at least one key on the keypad adapted to initiate an alpha search of application names or application settings, or both, that are stored in the memory, wherein the CPU provides results of the alpha search from the memory to the display.

12. A mobile communication device as recited in claim 11, wherein keypad comprises a plurality of alphanumeric keys, and the CPU accesses the application names and application settings based on inputs from the alphanumeric keys.

13. A mobile communication device as recited in claim 11, wherein the CPU further comprises a microprocessor.

14. A mobile communication device as recited in claim 11, wherein the at least one key is a soft key.

15. A mobile communication device as recited in claim 12, wherein the CPU is adapted to search the memory and provide matching application names and settings to the display.

16. A mobile communication device as recited in claim 11, wherein the memory includes a registry that includes the application names and application settings.

17. A mobile communication device as recited in claim 11, wherein the mobile communication device is one of: a mobile telephone, a personal digital assistant or a portable computer.

18. A mobile communication device as recited in claim 11, wherein the memory includes a cache memory that includes application names and application settings.

19. A mobile communication device as recited in claim 18, wherein each application name and each application setting is stored in two fields and one of the fields is a flag that identifies an application name or an application setting.
